(19) United States
(12) Patent Application Publication
(10) Pub. No.: US 2010/0042497 A1
(43) Pub. Date: Feb. 18, 2010

(54) Audience Manager and Data Exchange

(76) Inventors: Adam Pritchard, New York, NY (US); Alexander White, New Rochelle, NY (US); Johannes Schouten, New York, NY (US)

Correspondence Address: Stattler-Suh PC, 60 SOUTH MARKET, SUITE 480, SAN JOSE, CA, 95113, US

(21) Appl. No.: 12/191,498

(22) Filed: Aug. 14, 2008

(51) Int. Cl. G06Q 30/00; G06Q 99/00

(52) U.S. Cl. 705/14.49; 705/1; 705/14.55

(57) ABSTRACT

A method of data collection for user segmentation receives an interaction of a user with a web page, and generates an ad call in response to the received interaction. The ad call is preconfigured to have an association to a first segment. The method adds the user to the first segment.

### FIELD

The present invention is related to the field of exchange ad delivery systems, and is more specifically directed to audience manager and data exchange.

### BACKGROUND

Electronic exchanges, including online auctions, have proliferated along with the Internet. These electronic exchanges aim to provide a high degree of trading efficiency by bringing together a large number of buyers and sellers. Such centralized exchanges are focused on directly matching the bids and offers of buyers and sellers. Conventional transactions on the exchange are between (i) buyers and sellers, (ii) intermediaries (e.g., brokers, which may be a buyer or seller), or (iii) buyers or sellers and intermediaries.

The proliferation of Internet activity has also generated tremendous growth for advertising on the Internet. Typically, advertisers (e.g., buyers of ad space) and online publishers (sellers of ad space) have agreements with one or more advertising networks (ad networks), which provide for serving an advertiser's banner or ad across multiple publishers, and concomitantly provide for each publisher having access to a large number of advertisers. Ad networks, which may also manage payment and reporting, may also attempt to target certain Internet users with particular advertisements to increase the likelihood that the user will take an action with respect to the ad. From an advertiser's perspective, effective targeting is important for achieving a high return on investment (ROI).

Online advertising markets exhibit undesirable inefficiencies when buyers and sellers are unable to transact. For instance, although a publisher may be subscribed to many ad networks, and one or more of those ad networks may transact inventory with other ad networks, only one of the ad networks to which the publisher is subscribed is involved in selling (e.g., auctioning) a given ad space for the publisher. The publisher, or a gatekeeper used by the publisher, selects or prioritizes which ad network, or advertiser having a direct agreement with the publisher, serves the impression for a given ad request.

Within this document, one of ordinary skill recognizes certain abbreviations such as, for example, cost per impression, Cost Per Mille, or cost per 1000 impressions (CPM), cost per click (CPC), cost per acquisition (CPA), effective CPM (eCPM).

### SUMMARY

A method of data collection for user segmentation receives an interaction of a user with a web page, and generates an ad call in response to the received interaction. The ad call is preconfigured to have an association to a first segment. The method adds the user to the first segment. The user interaction of some embodiments includes such activities as loading the web page; clicking on a portion of the web page; and/or posting information in relation to the web page. The method performs a targeting function for the user such as, for example, by determining which entities are eligible to serve an ad for the ad call; by selecting an advertisement from an ad campaign of an eligible entity; and/or by delivering the selected advertisement for presentation to the user. In some cases, the ad call has a format that includes: a request for an advertisement for presentation on the web page; one or more requirements for the requested advertisement, and/or an identifier for the requesting web page. The requirements for an advertisement may include, for instance, a size requirement, and/or a type of ad requirement. In an implementation, the method uses a back end data storage coupled to a server for storing user segment information. The user segment information preferably includes segment identifiers that are unique for each segment. In an implementation, the method uses a user cookie space for storing user segment information on the user's local machine. As mentioned above, the user segment information preferably includes segment identifiers that are unique for each segment. The ad call is optionally triggered by using a pixel that is embedded within the web page.

A computer readable medium storing a program for data collection for user segmentation has sets of instructions. The instructions are for receiving an interaction of a user with a web page, and generating an ad call in response to the received interaction. The ad call is preconfigured to have an association to a first segment. The instructions are also for adding the user to the first segment. The user interaction comprises one or more of: loading the web page; clicking on a portion of the web page; and posting information in relation to the web page. Some embodiments further have instructions for performing a targeting function for the user such as, for example, by determining which entities are eligible to serve an ad for the ad call; by selecting an advertisement from an ad campaign of an eligible entity; and/or by delivering the selected advertisement for presentation to the user. The ad call has a format that may include: a request for an advertisement for presentation on the web page; an identifier for the requesting web page; and/or one or more requirements for the requested advertisement such as, for example, a size requirement, and/or a type of ad requirement. An implementation has instructions for using a back end data storage coupled to a server for storing user segment information. The user segment information includes segment identifiers that are unique for each segment. An implementation has instructions for using a user cookie space for storing user segment information (e.g., segment identifiers that are unique for each segment) on the user's local machine. The ad call is optionally triggered by using a pixel that is embedded within the web page.

A system for data collection for user segmentation is configured to receive an interaction of a user with a web page; and generate an ad call in response to the received interaction. The ad call is preconfigured to have an association to a first segment. The system is also configured to add the user to the first segment. The user interaction may include one or more of: loading the web page; clicking on a portion of the web page; and/or posting information in relation to the web page. The system of some embodiments includes a targeting module for performing a targeting function for the user such as, for example, determining which entities are eligible to serve an ad for the ad call; selecting an advertisement from an ad campaign of an eligible entity; and/or delivering the selected advertisement for presentation to the user. In an implementation, the ad call has a format that includes: a request for an advertisement for presentation on the web page; one or more requirements for the requested advertisement (e.g., a size requirement, and/or a type of ad requirement); and/or an identifier for the requesting web page. In an implementation, the system includes a back end data storage coupled to a server for storing user segment information such as segment identifiers that are unique for each segment. In an implementation, the system uses a user cookie space for storing user segment information (e.g., segment identifiers that are unique for each segment) on the user's local machine. The ad call is optionally triggered by using a pixel that is embedded within the web page.

### BRIEF DESCRIPTION OF THE DRAWINGS

The novel features of the invention are set forth in the appended claims. However, for purpose of explanation, several embodiments of the invention are set forth in the following figures.

FIG. 1 illustrates an exchange system in accordance with some embodiments of the invention.

FIG. 1A illustrates user cookie spaces having segment information.

FIG. 1B illustrates a back end data storage having segment information.

FIG. 2 illustrates an exemplary transaction by using an exchange system.

FIG. 3 illustrates an audience data exchange system according to some embodiments.

FIG. 4 illustrates an exemplary transaction within the audience data exchange system.

FIG. 5 illustrates a sale of data within a network at inhouse rates.

FIG. 6 illustrates a markup type sale of data from a first network to a second network.

FIG. 7 illustrates a reseller type transaction between networks according to some embodiments.

FIG. 8 illustrates an interface for managing audience segments where a seller manages various audience segments that the seller has defined for itself or for its managed data providers.

FIG. 9 illustrates an interface for adding a new segment where a seller defines a new segment.

FIG. 10 illustrates an interface for managing data providers where a seller views and/or updates various managed data providers with which the seller has a relationship.

FIG. 11 illustrates an interface for adding a new data provider where a seller defines a new managed data provider (MDP).

FIG. 12 illustrates an interface for managing data buyers where a seller designates which other entities on the exchange are approved as users of the segments belonging to this network or this network's managed data providers.

FIG. 13 illustrates an interface for data marketplace functionality where a seller explicitly exposes shared segments to approved buyers at a defined price.

FIG. 14 illustrates an interface that includes default settings where sellers set some convenient defaults for their data business.

FIG. 15 illustrates a process for temporary and/or global exchange opt outs.

FIG. 16 illustrates a process for granting permission to an entity on the exchange.

FIG. 17 illustrates a process for entity-specific opt out.

FIG. 18 illustrates a process for user segmentation and/or targeting.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

The present application incorporates herein by reference, the following documents and/or patent applications: U.S. patent application Ser. No. 10/______, entitled “SYSTEM & METHOD FOR LEARNING AND PREDICTION FOR ONLINE ADVERTISEMENT”; U.S. patent application Ser. No. 11/006,121 entitled “METHOD & SYSTEM FOR PRICING ELECTRONIC ADVERTISEMENTS”; U.S. patent application Ser. No. 11/669,690 entitled “OPEN MEDIA EXCHANGE PLATFORMS”; U.S. patent application Ser. No. 11/669,711 entitled “GLOBAL CONSTRAINTS IN OPEN EXCHANGE PLATFORMS”; U.S. patent application Ser. No. 11/669,716 entitled “OPEN EXCHANGE PLATFORMS”; U.S. patent application Ser. No. 11/669,756 entitled “REVENUE ADJUSTMENT PROCESS”; U.S. patent application Ser. No. 11/669,764 entitled “ENTITY LINKING IN OPEN EXCHANGE PLATFORMS”; United States Patent Application [30002-015001] entitled “PREDICTION ENGINES”; United States Patent Application [30002-019001] entitled “PREDICTION ENGINES”; U.S. patent application Ser. No. 11/772,965 entitled “DATA MARKETPLACE AND BROKER FEES”.

Some embodiments of the invention include a Right Media exchange (RMX) that preferably includes audience data and/or an audience manager application. The data exchange and audience manager functionality may be formed by using one or more managed data providers (MDP). In some audience manager instantiations, however, the data providers are not required and a seller on the exchange alternatively sells only the seller's own segments, or segmented audience data. The media and/or data exchange is comprised of networks, publishers and advertisers. More specifically, embodiments of the invention involve the sharing and monetization of audience segment data via cookies or other means. In addition to allowing sellers of data to selectively permission buyers to use the data, some embodiments also incorporate pricing of data to modify ad calls, and/or track payments due between parties. The foregoing may be implemented by using platform-level functionality. Further, the foregoing allows new categories of entities to run businesses on an ad platform, with required functionalities, protections, and reporting. These features are further described below.

Audience Manager and/or Exchange

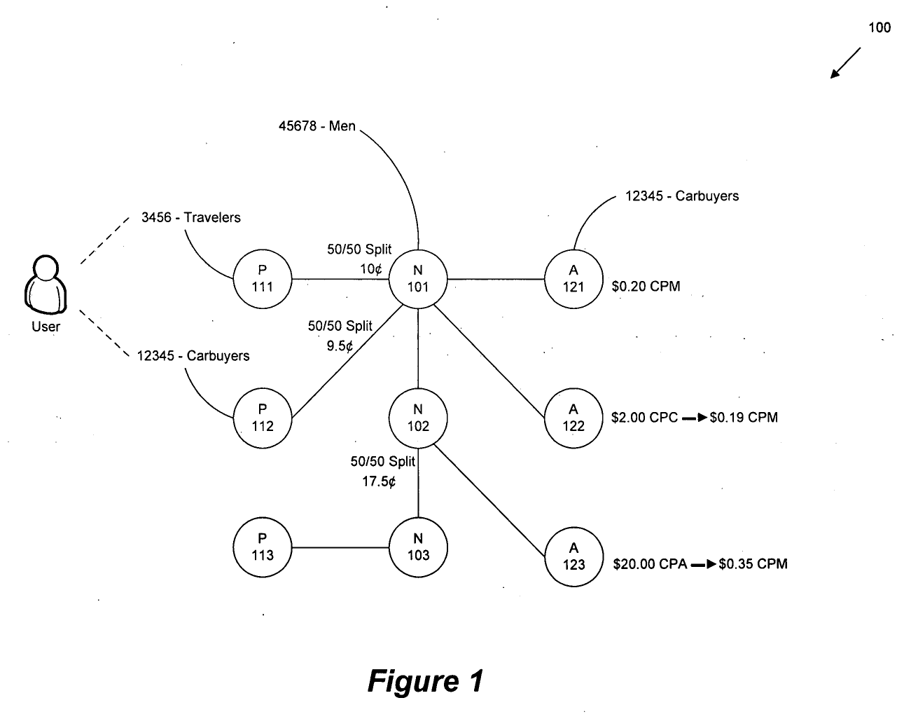

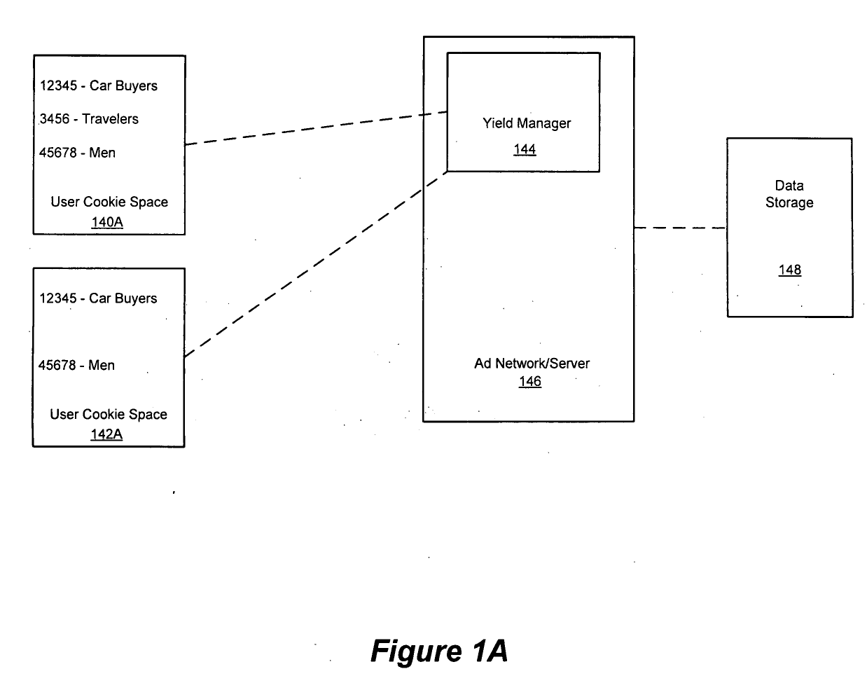

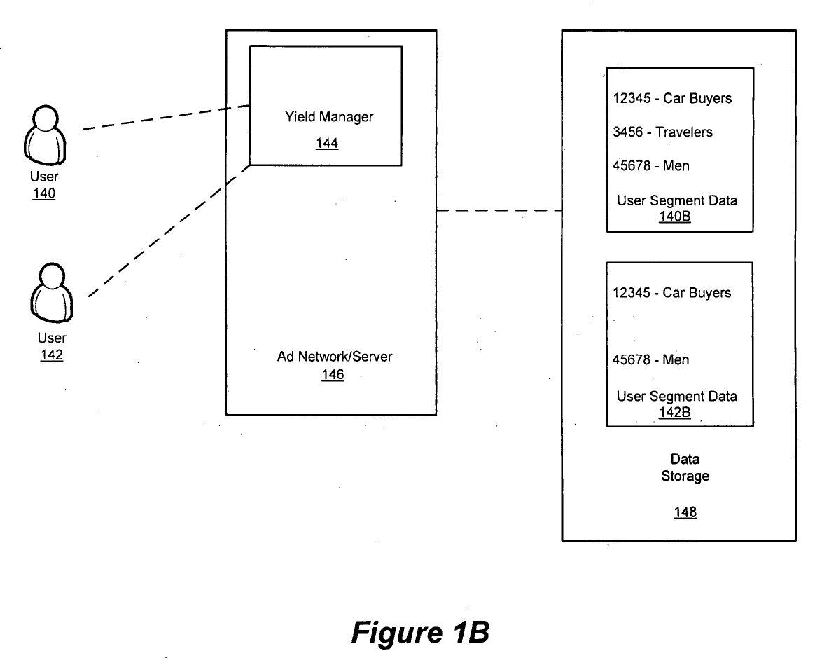

FIG. 1 illustrates an exchange system 100, which includes several exemplary entities that participate in the exchange system 100. As shown in this figure, the entities include networks 101, 102, 103, publishers 111, 112, 113, and advertisers 121, 122, 123. One of ordinary skill recognizes that the foregoing entities are exemplary and that the exchange 100 may contain other networks, publishers, advertisers, and/or other entities.

The publishers 111, 112, 113 preferably have content that is of interest to consumers of such content. For instance, the publisher 112 may have a web page such as Edmunds.com that is directed to car buyers. Users of the Internet may visit the web page to obtain the content provided. Some embodiments log the visits and/or activities of the users on the web page, and further generate segments of users who interact with the content. As shown in the figure, the publisher 111 may have content for travelers, while the publisher 112 has content for car buyers. Each segment preferably has a unique identifier that is unique to the segment, and is also unique to the entity. In this example, the segment “Car Buyers” for the publisher 112 is assigned the identifier “12345, ” the segment “Travelers” for the publisher 111 is assigned the identifier “3456,” and the segment “Men” is assigned the identifier “45678” for the network 101.

As users and/or segments of users interact with the content provided by the publishers 111, 112, 113, “ad calls” are generated for the publishers' advertising inventory. Generally, the advertisers 121, 122, 123, bid to supply advertising to the available inventory. In this case, the advertiser 121 bids $0.20 CPM, the advertiser 122 bids $2.00 CPC, and the advertiser 123 bids $20.00 CPA. Some systems normalize the bids and/or costs to CPM. Hence, the $2.00 CPC may be normalized to $0.19 CPM, and the $20.00 CPA to $0.35 CPM. Further, the networks 101, 102, 103 may have split fee arrangements with the publishers 111, 112, 113. FIG. 1 illustrates 50/50 split fee arrangements between each publisher 111, 112, 113, and each network 101, 102, 103. More specifically, for the $0.20 CPM the advertiser 121 pays for presentation of its advertising to users/consumers, the advertiser pays $0.20 CPM to the network 101, which the network 101 shares or splits with the publisher 111. Other fee arrangements, however, are recognized by one of ordinary skill.

The advertisers 121, 122, 123 typically have advertising campaigns that include one or more ad creatives that promote a particular brand or product. The advertisers 121, 122, 123 may wish to specify certain criteria for each campaign such as, for example, maximum spend per day on the delivery of advertising, and/or criteria for targeted advertising. Examples of “hard targeting” include directing an advertisement to a particular gender and/or during a particular time of day. The advertisers 121, 122, 123 may further target particular users and/or segments of users. As discussed further below, particular transactions and/or data have additional value for the exchange system 100. For instance, one or more ads and/or campaigns for the advertiser 121 may have particular relevance to the Car buyers 12345.

In one implementation, an ad server maintains a history of attributes for several advertisements, and predicts the value per advertisement in relation to each publisher. The ad server may perform the foregoing alternatively, or in conjunction with, behavioral type targeting based on user data. In some of these embodiments, each user has a cookie space that is used by various entities to store information. For instance, one or more entities within the exchange system 100 advantageously write into a user's cookie space an integer identifier that corresponds to a particular user segment. FIG. 1A illustrates a user cookie space 140A that has some stored segment identifiers such as, for example, 12345-CarBuyers, 3456-Travelers, and 45678-Men, that are advantageously used to target and/or generate the users and/or segment(s). A separate user cookie space 142 A may store different segment identifiers based on a different user's interests and/or activities such as, for example, user 142 in FIG. 1B. Alternatively, information such as user segment data is stored in a back end data storage or user data storage (UDS) 148 that is coupled to the server illustrated in FIG. 1A. Such an implementation is further illustrated in FIG. 1B. As shown in FIG. 1B, user segment information, such as segment identifiers 140B and 142B are stored for the users 140 and 142, respectively, on the user data storage 148, rather than using local user cookies. The user data storage 148 may use a tabular and/or data base format. Regardless of the particular implementation, such as format or location, an application 144 advantageously uses the user data for targeting and other purposes.

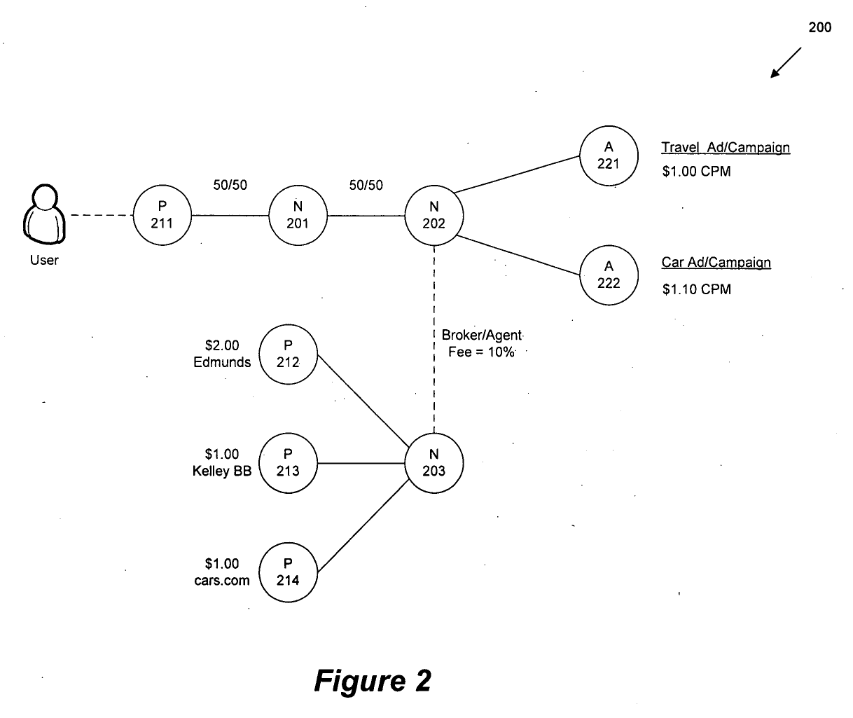

More specifically, FIG. 2 illustrates an exemplary transaction by using an exchange system 200. As generally shown in this figure, the networks 201 and 202 may have a fee splitting arrangement. Moreover, the network 202 may have a broker fee arrangement with another network 203 for an advertiser 222 of cars on the network 202, and for several publishers 212, 213, 214 of car buying information on the network 203. Such transactions are described in further detail in the U.S. patent application Ser. No. 11/772,965, incorporated by reference above. The transaction of FIG. 2 is one example of the advantages of user and/or user segment data on the exchange 200. For instance, the advertiser 222 is likely to bid more to target a user visiting the publisher 211, if it is known on the exchange that the user recently visited the publishers 212-214, and/or is in the user segment “car buyers.”

The application Ser. No. 11/772,965, and the additional applications incorporated by reference above mention pixels and generating data such as by using the pixels. In this document, there are at least four ways to generate user segments. (i) One way is to add a user to a segment when the user views a section of a web site and/or when an ad call is generated by the serving of a web page. (ii) Another way is to add a user to a segment when the user views impressions of ads that are presented to the user. (iii) Alternatively, a user is added to a segment when the user clicks on or through an advertisement. (iv) In some embodiments, a segment is formed by using a pixel on a web page that logs a user's browser and/or cache loads of the pixel and thus the user's visits to the web page. Portions of the discussion herein refer to pixels, and data generation by using the pixels. One of ordinary skill, however, recognizes applicability to the several forms of data acquisition and/or generation such as by using ad calls further described below.

Generating, Managing, and/or Selling Data

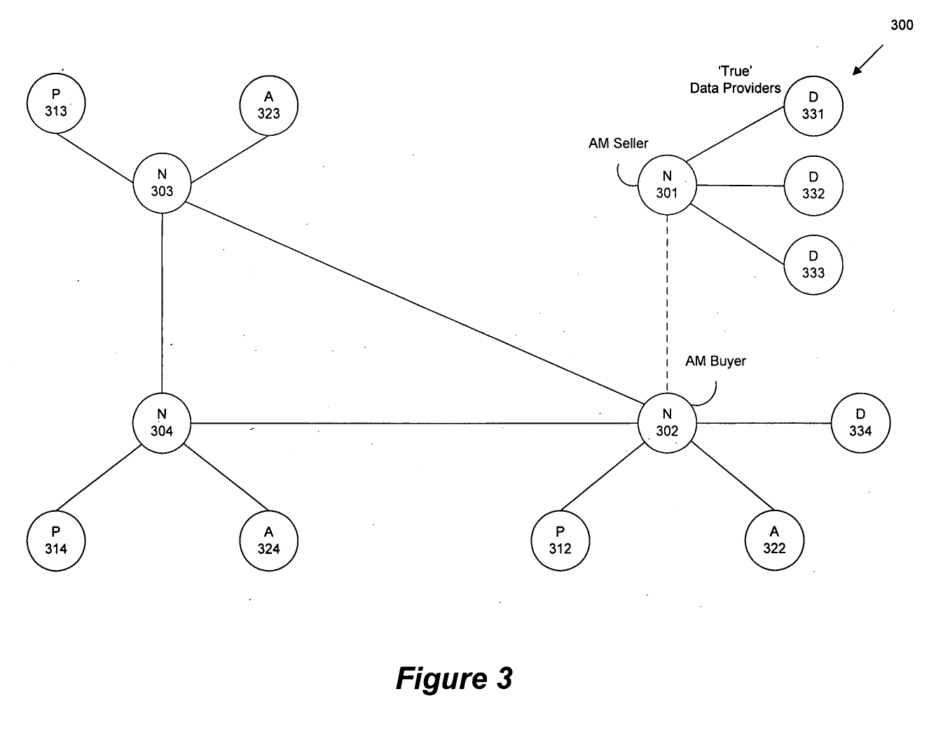

FIG. 3 illustrates an audience data exchange system 300 according to some embodiments. As shown in this figure, the system 300 includes several entities such as networks 301, 302, 303, 304, that each has a set of associated publishers 312, 313, 314, and advertisers 322, 323, 324. Some networks 301, 302, 303, 304 further have associated data providers 331, 332, 333, 334. The data providers 331, 332, 333, 334 advantageously collect a variety of data from the system 300 or from another source, and provide that data for sale on the exchange system 300, preferably, via one or more networks 301-304. For instance, the data provider 331 may collect data to generate and/or update the segment Car Buyers 12345 discussed above, and offer this data for sale on the exchange system 300, preferably, by using one or more of the networks 301-304 as a seller of the data provider's data.

In one embodiment, the data provider 331 is associated to the network 301, which manages the data provider 331. Moreover, the network 301 acts as the seller for data sold on the exchange 300 from the data provider 331, for example, to the network 302, which acts as a buyer for its associated entities such as the publisher 312, and the advertiser 322. The data provider 334 may also purchase data from the network 302, and/or directly from the data provider 331, in a reselling arrangement. The particular labels and functions of each entity such as seller, buyer, data provider, and the like, are exemplary at a point in time to facilitate explanation. Sellers and buyers may interchange roles in other transactions at other times, and a publisher or advertiser may act as a data provider at various times during operation of the exchange 300. As further described herein, the seller selectively prices audience segments on a per-buyer basis. Moreover, the seller of each transaction may selectively permission the audience segment, and/or the buyer for each transaction within the exchange system 300. Some embodiments, more specifically use pixels embedded into web pages for capturing and/or generating data. In these embodiments, the pixels are managed by an entity, such as a data provider, within the exchange.

In the present example, a data provider 331 advantageously develops data that has value to another entity within the exchange system 300 such as, for example, a segment for potential car buyers. Accordingly, the network 302 wishes to provide the segment from the data provider to one or more of its associated entities. For instance, the publisher 312 has a web site catering to car buyers, and/or the advertiser 322 has an advertisement for a car. In this case, the seller network 301 has a fee sharing arrangement with the data provider 331, for fees from the buyer network 302 including the publisher 312, and the advertiser 322. Alternatively, the network 302 has an arrangement to provide the car buyer segment (purchased from the network 301 ) to the network 304, to associates of the network 304 such as the publisher 314, to the advertiser 324, and/or to another entity within the exchange.

When users interact with the publisher's 312 content, one or more ad calls are generated for the publisher's 312 inventory. For instance, the publisher 312 typically has several web pages that include multiple inventory locations on each page for advertisements that present valuable ad/branding impressions to the users of the publisher's 312 content. The publisher 312 and/or the network 302 use the segment purchased from the seller network 301 to target the advertising to the users by placing specific ads with specific inventory at certain times. In a particular implementation, a user interacts with the publisher's 312 content, and the system 300 uses the user's beacon and/or segment history (e.g., cookies) to determine that the user is associated with the data provider's 331 segment developed for car buyers, and advantageously selects one or more advertisements from the advertiser's 322 car ads/campaigns. As impressions are generated for the users of the publisher's 312 content by using targeted advertisements from the advertiser 322, the particular revenue sharing arrangements between the data provider 331 and the networks 301 and 302, are advantageously implemented. One of ordinary skill recognizes a variety of revenue sharing agreements including, for example, split fee, flat fee, and the like. Preferably, the foregoing is implemented and aggregated in high speed and/or real time across the system 300. More detail regarding this and other transactions are further described below. The foregoing example applies to other entities within the exchange 300 such as, for example, the exemplary publisher 313.

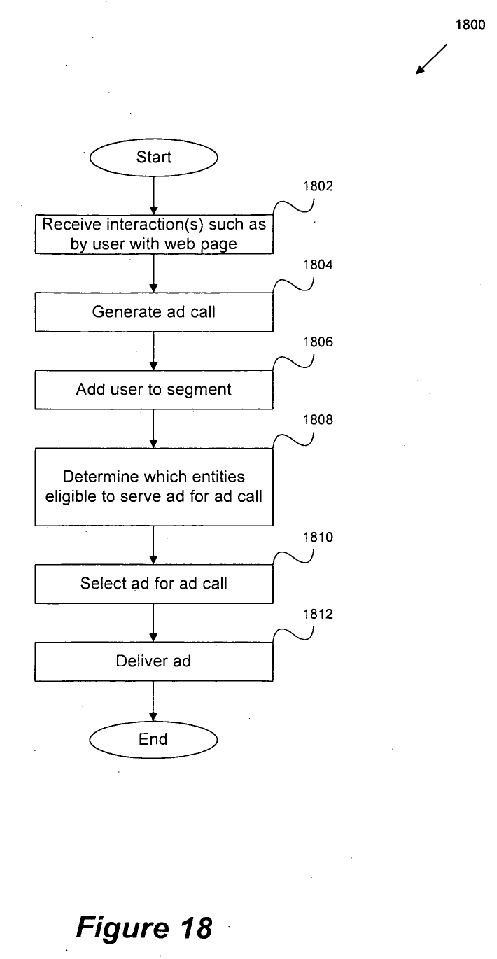

An alternative to using pixels for user segmentation, is to use ad calls on the web page. The ad calls may or may not also request an advertisement for delivery of an ad impression to a user. FIG. 18 illustrates a process 1800 for user segmentation and/or targeting. The process 1800 advantageously uses an ad call to add a user to one or more segment(s), and optionally to serve an ad to the user. As shown in this figure, the process 1800 begins at the step 1802, where a user interacts with a web page. The user interaction includes, for example, page loads, clicking, posting, and the like. Then, the process 1800 transitions to the step 1804, where an ad call is generated in response to the user interaction at the step 1802. The ad call generally has a format that includes a request for an advertisement for presentation on the web page, certain requirements for the advertisement (e.g., size, type of ad), and/or the location or identity of the requesting web page. In some implementations, the ad call includes additional information or performs additional functions.

For instance, at the step 1806, the ad call of a particular embodiment adds the user to one or more segment(s). Preferably, the ad call is preconfigured to add the user to specific segment(s). For instance, when the web page is Edmunds.com, and the ad call returns an advertisement for a car brand, then the ad call may add the user to the Car Buyer segment described above. Some embodiments use the back end data storage described above in relation to FIG. 1B for storing the user segment information. The foregoing embodiments may be used alternatively, or in conjunction with, pixels and/or user cookie space(s) for segmenting and/or storing user segment information described above in relation to FIG. 1A.

Once user segmenting is performed and/or stored at the step 1806, the process 1800 may optionally transition to the step 1808 to perform various targeting functions for the user. For instance, at the step 1808, some embodiments determine which entity(s) are eligible to serve ads for the ad call based on the information provided by the ad call and/or request for advertising. Then, at the step 1810, an ad is selected from the eligible ads and/or entities for the ad call. Once one or more ads are selected then, at the step 1812, the selected ad is preferably delivered in response to the ad call. After the step 1812, the process 1800 concludes.

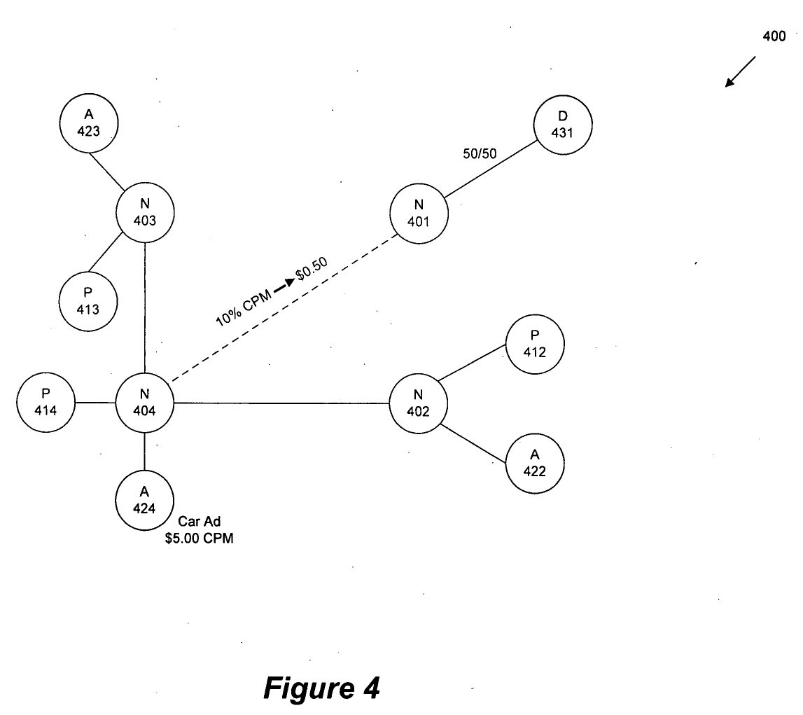

FIG. 4 illustrates an exemplary transaction within the data exchange system 400 of some embodiments in further detail. As shown in this figure, a data provider 431 has a 50/50 fee splitting arrangement with a network 401, which acts as a seller of its data to a buyer network 404. The buyer network 404 purchases the segment for a fee of 10% of CPM. The bid/price of the advertiser 424 for targeted presentation of its advertising to users by using the data provider's 431 segment is $5.00 CPM, which is typically shared with a publisher or network having inventory and presenting the impressions, and with the network 404 that provides various publishers' inventories and/or data providers' data to the advertiser 424, through purchase, collection, distribution, and/or other means. Hence, the fee between the networks 404 and 401 for the segment is $0.50 per 1000 impressions.

As described above, embodiments of the invention include a number of useful features. These features include: allowing entities that possess user data to sell it to other entities through a market exchange type system, allowing entities that wish to target specific segments of the Internet audience to do so by using another entity's segment, providing a unified technological platform to enable the various features described herein, allowing an entity to compensate another entity for building an audience segment, embedding the pricing of segment into ad call transactions to influence the outcome/efficacy of the targeting and/or ad call, and/or thereby generating a marketplace for audience segments. More details and features of various embodiments are further described next.

In-House Pricing

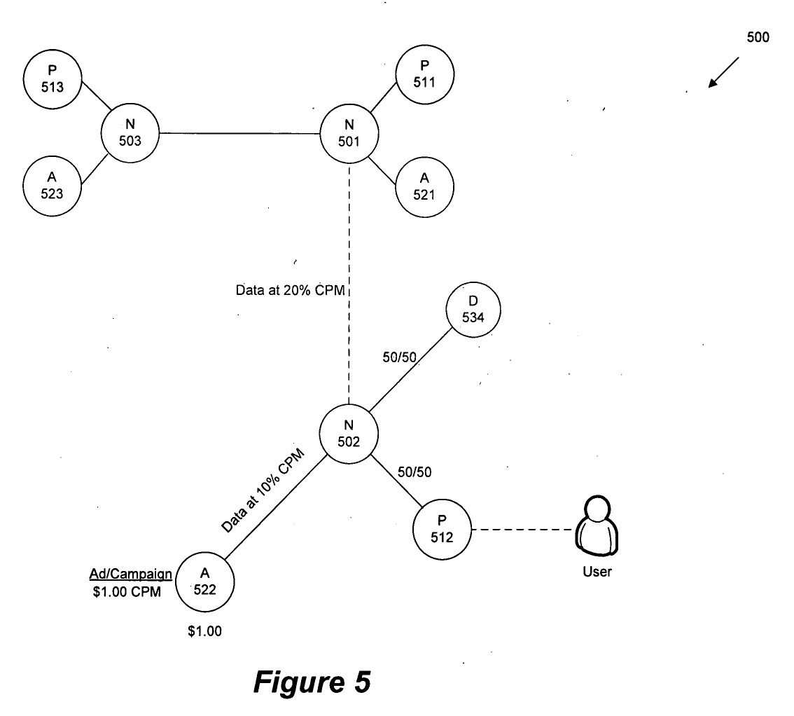

FIG. 5 illustrates an example of in-house pricing within an exchange system 500. As shown in this Figure, a seller, which in this case is a network 502, may target the seller's 502 own pixels and/or segments at different in-house rates. For instance, the seller 502 may sell data from a data provider 534 within its network to a buyer such as a publisher 512 and/or an advertiser 522 also within its network at in-house rates that differ from the rates that the seller 502 charges to a buyer outside its network of associates. In this example, the in-house advertiser 522 wishes to spend $1.00 CPM, from which the network 502 allocates data fees at $0.10 and allocates ad inventory fees at $0.90. Hence, the in-house data provider 534 receives $0.10, and the in-house publisher 512 receives a 50/50 split of the $0.90, or $0.45. Alternatively, the network 502 allocates data fees at $0.05 (for the data provider 534), and the publisher 512 receives a 50/50 split of $0.95 from the network 502, and each of the network 502 and the publisher 512 receive $0.475 from the transaction of FIG. 5. In contrast, the network 502 allocates a higher data fee to purchasers of data that are outside of the network 502 such as, for example, $0.20 CPM pricing for data to the network 501 that is external to the network 502.

Markups

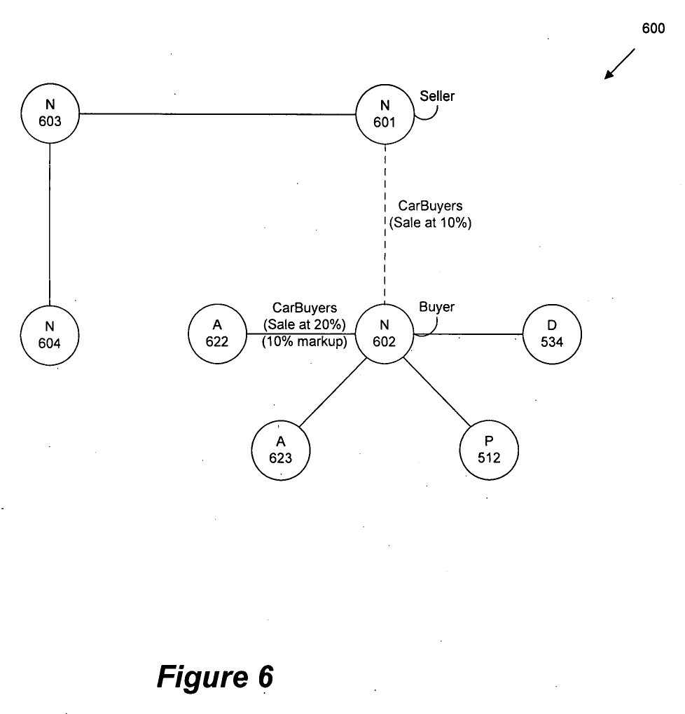

FIG. 6 illustrates a markup type sale of data from a first network to an entity associated with a second network within an exchange system 600. As shown in this figure, in some cases intermediaries set markups on data. For instance, a seller network 601 sells data relating to a car buying segment to a buyer network 602 at 10% of a bid price (e.g., 10% revenue share). The buyer network 602 may pass the cost to its associated entities, or may add a markup of 10%, for example. Hence, an advertiser 622 that purchases the data from the network 602 pays 20%, and the network 602 earns the 10% markup from the sale of the data from the network 601 to the advertiser 622.

Data Exchange Resellers

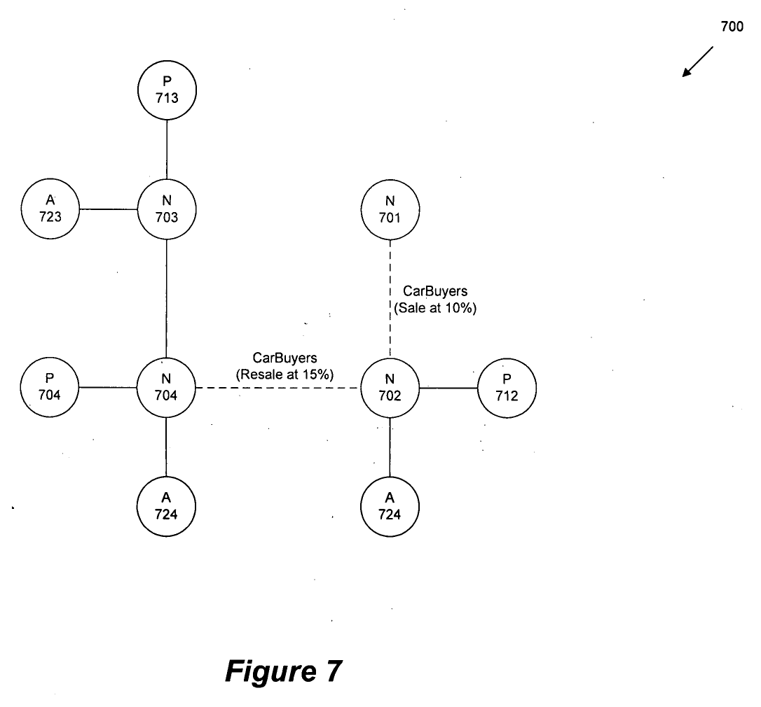

FIG. 7 illustrates a reseller type transaction between networks within an exchange system 700 according to some embodiments. As shown in this figure, permissioned entities advantageously resell other sellers' segments to buyers within the data exchange 700. More specifically, a network 701 sells a segment relating to a car buying segment to a network 702, which resells the segment to another network 704. In this example, the first sale is at 10% pricing, while the resale is at 15% pricing (e.g., using fixed or revenue sharing pricing models). As described above, sellers selectively price and/or expose segments for sale, and also for resale. Preferably, the data seller controls which entities are authorized resellers of the data. In some cases, only one level of indirection is supported such that the network 704 may not resell the segment purchased from the network 701. For instance, one control mechanism allows sellers to block certain pixels and/or segments from resale by each reseller as needed. Another mechanism allows sellers to exclude and/or blacklist entities to which a reseller may not sell (e.g., the segment purchased from the network 701 is not resold by the network 704 to the network 703 without permission, and/or the sale of the segment to the network 703 is reserved for the network 701).

Custom Segments

Some embodiments include the ability to bundle individual segments together to form custom segments. These embodiments preferably include features for managing and pricing custom segments. Custom segments are used separately or in conjunction with base or non custom segments such as, for example, for intensity targeting further described below. In one implementation, a custom segment is built by using a Boolean expression such as from a set of either ANDed or ORed segments, for instance. Below are example individual segments S1-S5 and combinations of these segments by using AND/OR logic. One of ordinary skill, however, recognizes many other combinations including more complex expressions with or without the use of Boolean logic.

| | Segment ID | | | | |
|---|---|---|---|---|---|
| | S1 | S2 | S3 | S4 | S5 |
| SegmentName | Edmunds.- | KBB.com | Carbuyer.- | Travel | Business |
| | com | | com | | |

CustomSegment1 = (S1 || S2 || S3)
CustomSegment2 = (S1 & S2 & S3)
CustomSegment3 = (S4 & S5)

The pricing for custom segments may be more complex than for individual segments because of the combinations. For the CustomSegment1, the payout to the data provider may be at 10% CPM. Some systems calculate the payout distribution by paying the 10% fee to the data provider of the segment S1, or the segment S2, or the segment S3. One algorithm selects the data provider to pay randomly such that each of the three data providers that provide the data S1, S2, S3, for the CustomSegment1 effectively receive an equal distribution. Alternatively, the system pays the data provider having the segment S1, S2, S3 that was most recently added to the particular visiting user's cookie.

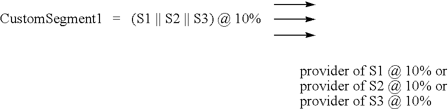

For the CustomSegment2, the payout to the data provider may be at 20% CPM, and some systems divide each payout distribution equally among the data providers of the ANDed data that forms the CustomSegment2.

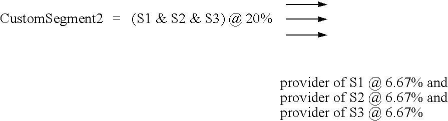

One of ordinary skill recognizes that the examples of attributing revenue for the data provider(s) of a custom segment described herein are for purposes of illustration, and further recognizes alternative revenue distribution schemes.

A custom segment is not restricted to combinations of non custom segments, Boolean or otherwise. Some custom segments comprise an alias to a real (non custom) segment. In these cases, the alias or custom segment is for providing a new and/or alternative name for the non custom segment.

In another embodiment, a custom segment is an intensity targeted segment having a different name and composition of users than a non custom segment upon which the intensity targeted (custom) segment is based. For instance, some embodiments form a custom segment by placing intensity targeting, e.g., recency and/or frequency, limitations on one or more non custom segment(s). The custom segment preferably includes a band-limiting parameter that includes a (band-limited) subset of the real or base (non custom) segment upon which the custom segment is based. In the case of the Car Buyers segment, for example, a custom segment thereof may include only Car Buyers (users) who have been added to the segment in the last month, and/or may include Car Buyers (users) who have been added to the Car Buyers segment greater than N times, and/or less than M times, for example. Hence, the intensity targeted and/or limited custom segment has an intensity band-limiting parameter for distinguishing the custom segment from the base (non custom) segment.

Exclude Targeting

A particular implementation allows targeting by excluding a segment rather than including a segment. Pricing for this feature may use a flat fee type arrangement, for simplicity. The following is an example of a custom segment that includes the segment S4 Travel, and not the segment S5 Business, which may be used to effectively target users interested in travel that is not business travel.

CustomSegment4=(S4 &! S5 ).

Intensity Targeting

Intensity targeting features are provided to entities such as buyers of data on the exchange, and/or to the sellers for the buyers. Intensity targeting allows buyers of data to purchase and/or target specific useful aspects of user segments. For instance, a data buyer may wish to purchase data and specifically target users having higher intensity activities. These higher intensity activities may include recency or frequency of addition to a segment such as by one of the four methods of adding a user to a segment discussed above (e.g., when a user visits a particularly relevant web page). In the Car Buyer segment example, a network entity that is a buyer of data may wish to purchase for one of the advertisers in its network of associates, a car buying segment that, for example, contains users who have most recently visited a set of web pages devoted to car buying advice. Additionally, and/or alternatively, the network entity (buyer) may wish to purchase a car buying segment that, for example, contains users who have most frequently visited the set of car buying advice web pages.

### II. Operator Functions and Interfaces

Media Exchange Administrator

Exemplary implementations include functionality that allow an administrator and/or selectively enabled operators to independently permission data exchange buyers, sellers and resellers. The functionality is generally implemented by using one or more applications, tools, and interfaces. The functions advantageously performed are further described next in relation to particular operators of these applications and interfaces.

Data Exchange Sellers

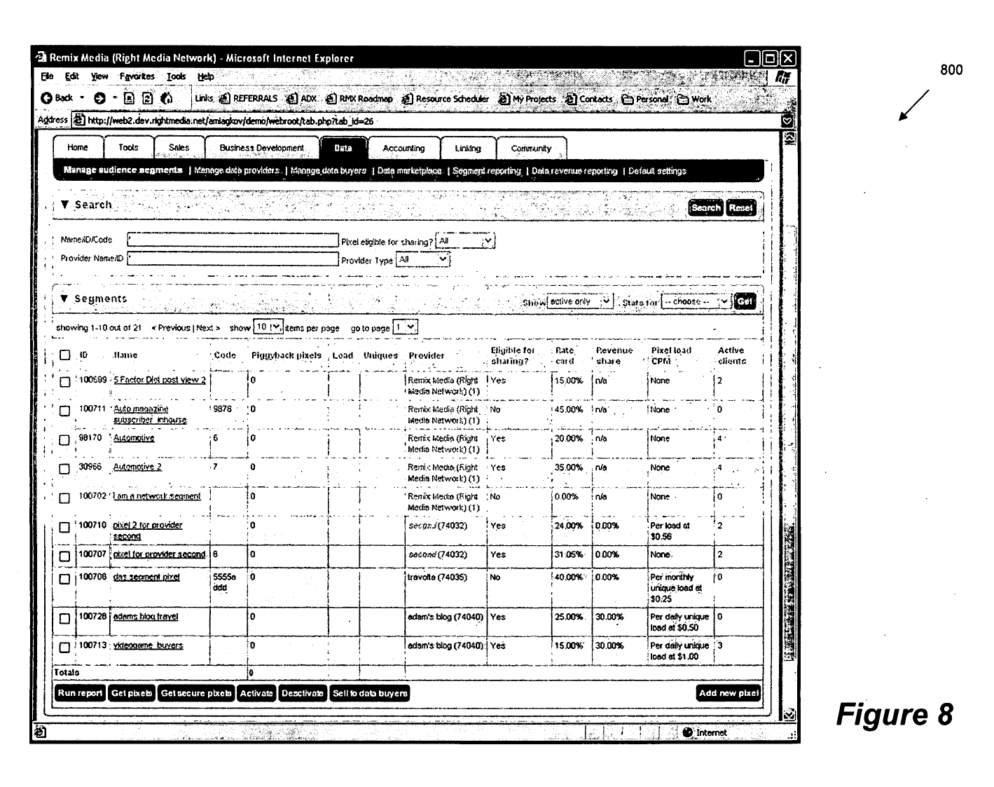

In one implementation, a seller within the data exchange must be a network type entity. Sellers within the data exchange are provided a variety of features. Some of these features mentioned above are accessed by using an “Audience” tab or a “Data” tab, further described below in relation to FIG. 8, or a similar tool.

Seller Managed Segments

Sellers within the exchange advantageously manage audience segments and/or sets of segments. For instance, sellers may grant permission to generate and/or update segments. As described above, there are at least four ways to generate the segments. A seller of some embodiments, selectively disables one or more ways to generate and/or expand a segment to control the segments, the data providers, and/or the use of the segments.

FIG. 8 illustrates an interface 800 for managing audience segments where a seller views various audience segments that the seller has defined for itself or for its managed data providers. As shown in this figure, the interface 800 is accessed by using the “Data” tab or similar within a manager application. The interface 800 includes a search function for finding a particular managed segment by using the segment name, or identifier, and/or by the provider of the segment (the data provider). The interface 800 provides a variety of useful information such as regarding pixels, loads, unique adds and/or loads, whether the segment is eligible for sharing, rate card, and revenue sharing data.

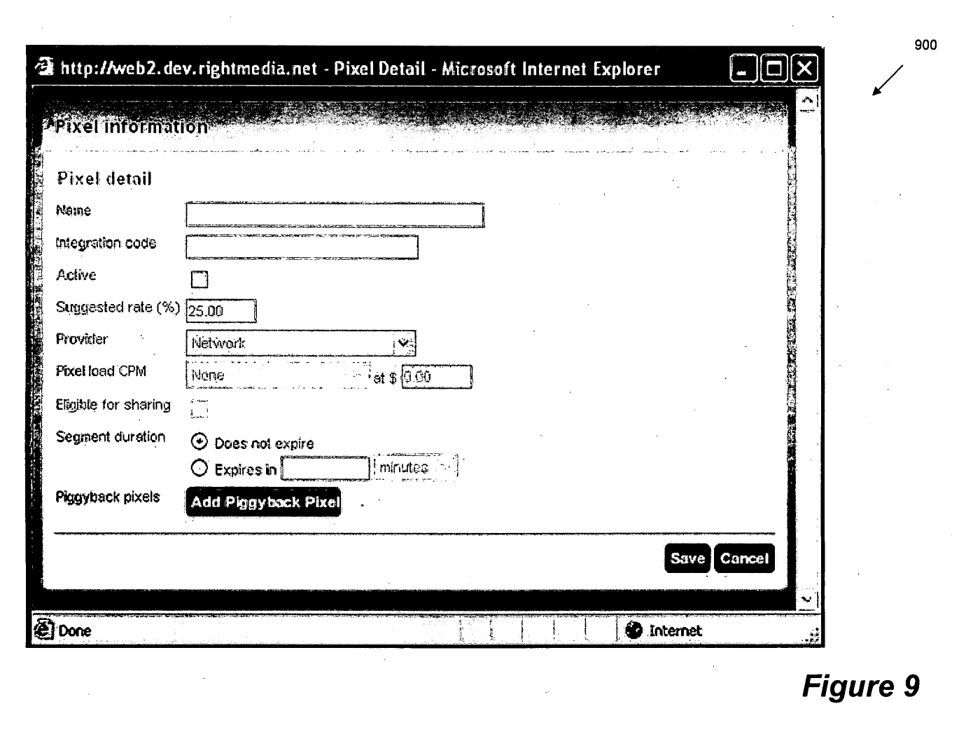

FIG. 9 illustrates an interface 900 for adding a new segment where a seller defines a new segment. The interface 900 is launched from an “Add new pixel” button such as within the interface 800 of FIG. 8. An operator of the interface 900 denotes the segment as belonging to the network itself or one of the network's managed data providers by using the “Provider” dropdown menu/field shown in the interface 900. Preferably, only segments belonging to a managed data provider are assigned a “pixel load CPM”. The pixel load CPM is the money earned by a data provider whenever a user is added to a segment. The interface 900 has a number of fields where the operator enters information/settings for presentation within the interface 800 of FIG. 8 such as, for example, suggested rate (%) pricing for use of the segment data, pixel load CPM, whether the segment is eligible for sharing, the segment duration, and/or whether the segment expires.

Seller Managed Segments

Sellers within the exchange advantageously generate and/or manage segments. The managed segments are owned by a network, or owned by a data provider. In these implementations, the seller sets rate card prices per segment. Further, a seller sets the pricing type such as, for example, flat pricing and/or revenue share pricing.

Seller Managed Data Providers

Sellers within the data exchange are able to generate and maintain managed data providers. For instance, a seller may set revenue shares with its managed data providers. Further, a seller may set default payout methods per managed data provider. Sellers may select payout by pixel loads, by daily unique, and/or by monthly unique visits to a site and/or adds of a user to a segment. Further, a seller may restrict by geographical criteria.

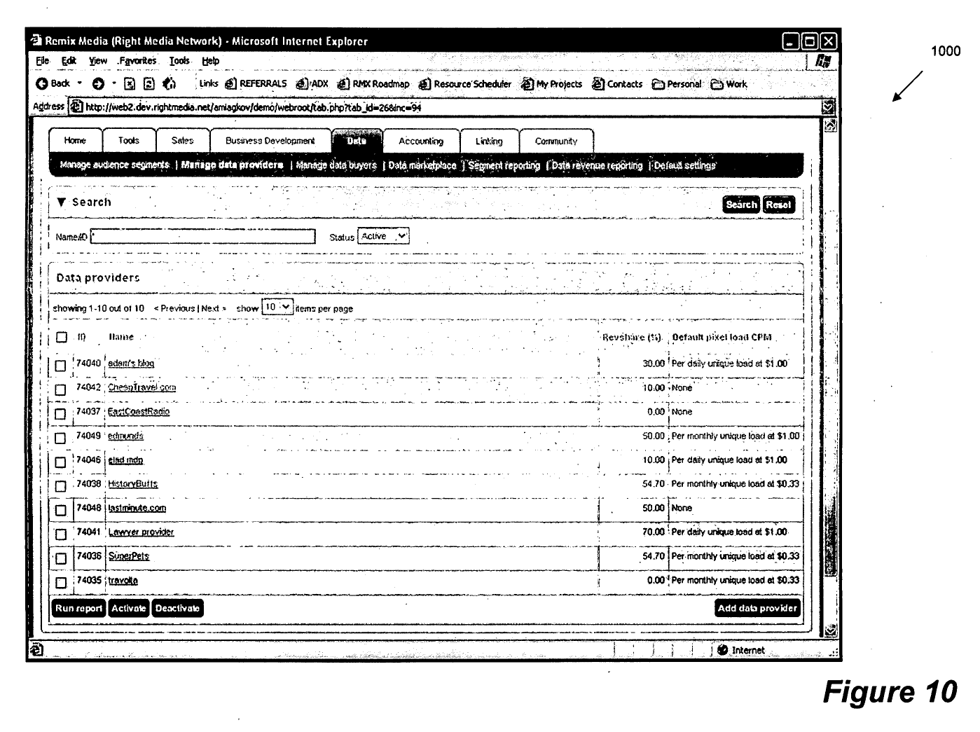

FIG. 10 illustrates an interface 1000 for managing data providers where a seller views and/or updates various managed data providers with which the seller has a relationship. As shown in this figure, the interface 900 includes a search feature for locating a particular data provider. The exemplary data providers include web sites such as “adam's blog,” “CheapTravel.com,” and “edmunds” among others. Each data provider listed includes available information regarding the operator's relationship with the data provider such as revenue sharing (%), the default load payout mechanism (e.g., all, daily unique, monthly unique), and a default CPM for load activities counted.

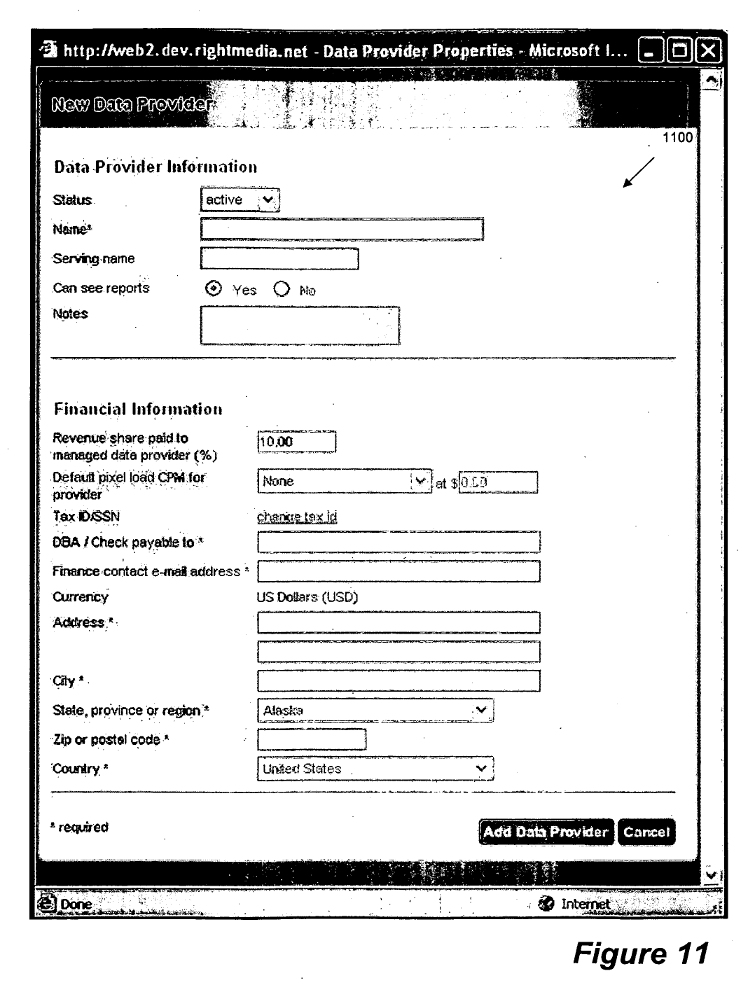

FIG. 11 illustrates an interface 1100 for adding a new data provider where a seller defines a new managed data provider. The interface 1100 is launched from an “Add data provider” button in FIG. 10. As shown in FIG. 11, a user may define the revenue share that the managed data provider receives on money earned by the network as a result of other networks targeting this managed data provider's segments across the exchange. This and other information are entered in the fields of FIG. 11, and are preferably displayed in the interface 1000 of FIG. 10.

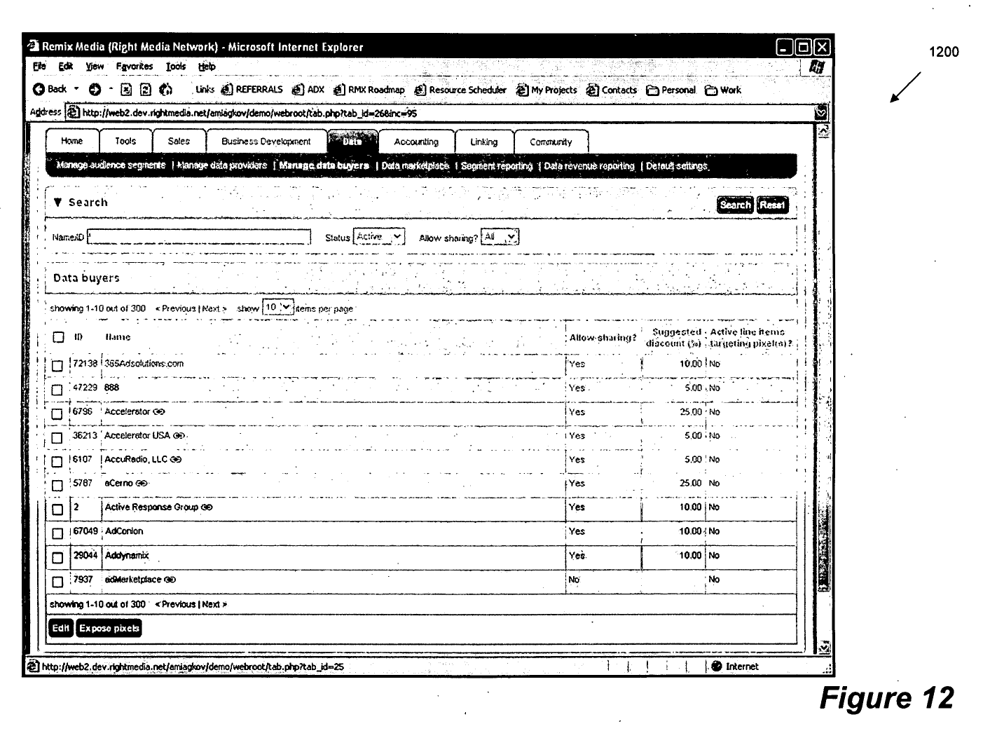

FIG. 12 illustrates an interface 1200 for managing data buyers where a seller designates which other entities on the exchange are approved as users of the segments belonging to this network or this network's managed data providers. As shown in this figure, several entities within the exchange system are listed as potential data buyers. The operator selectively enables the entities to allow sharing. The operator of the interface 1200 may further have a relationship with the data buyer that warrants a suggested discount (%). For permissioned buyers, the interface 1200 displays whether the data buyer has active advertising line items that are targeting pixel(s) and/or segments that are managed by the operator of the interface 1200, or another's pixel(s) and/or segments.

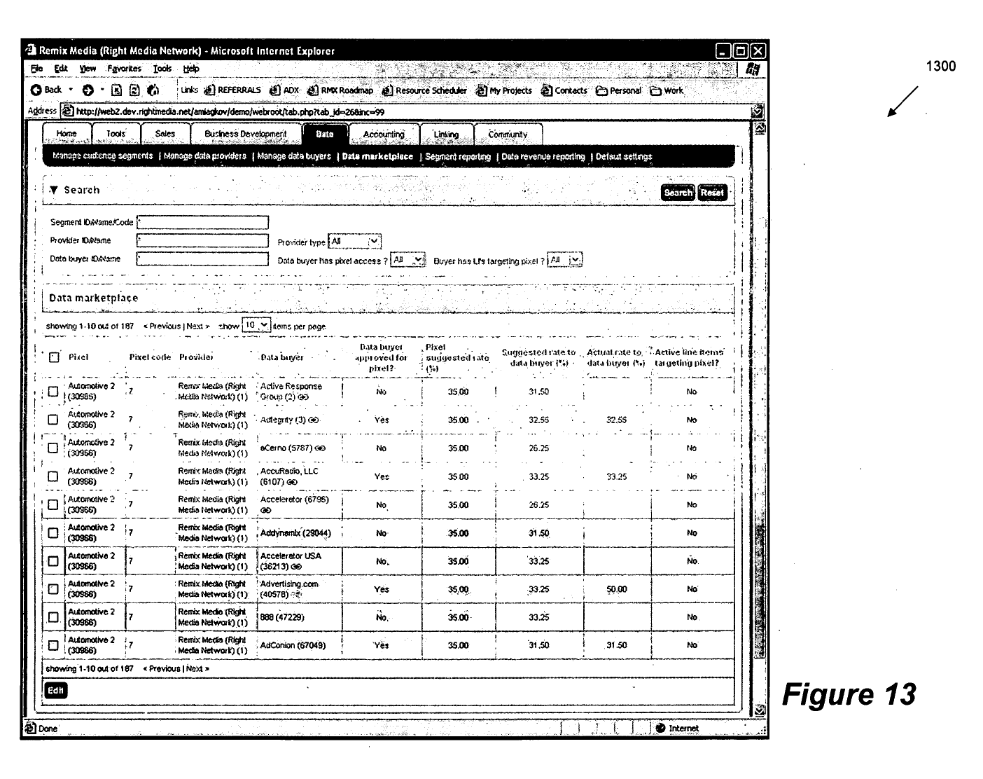

FIG. 13 illustrates an interface 1300 for data marketplace functionality where a seller explicitly exposes shared segments to approved buyers at a defined price. Some systems provide a “suggested rate” that is equal to a “segment rate card price” less any “buyer discount”. The defined price, however, may be different than the system suggested rate.

Convenient Defaulting

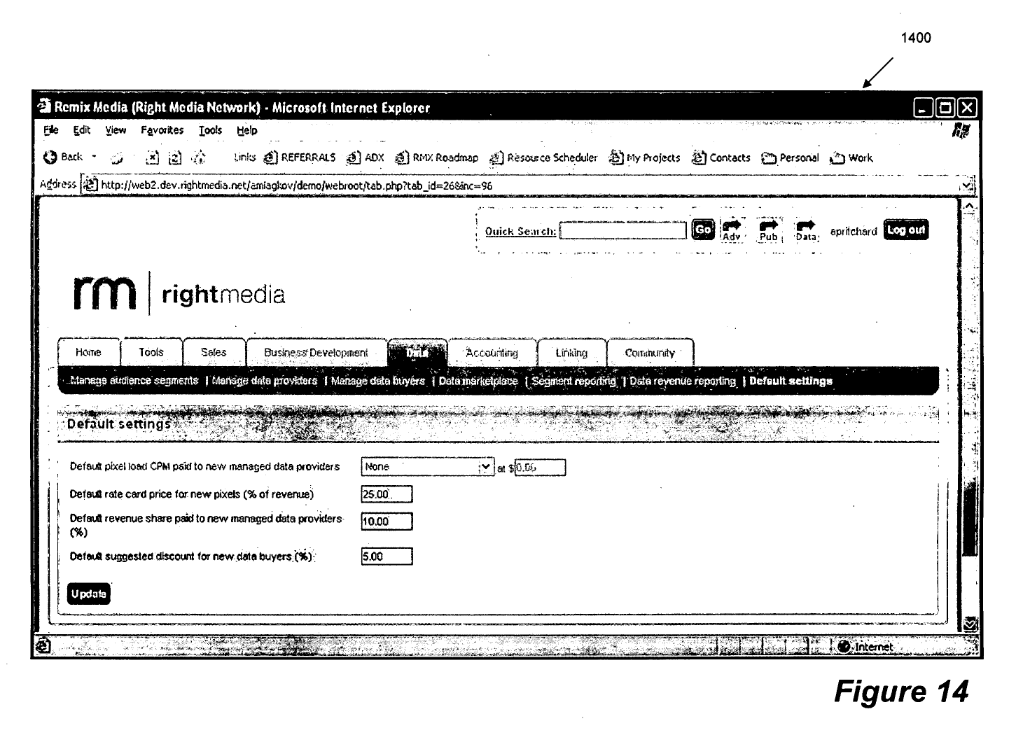

FIG. 14 illustrates an interface 1400 that includes default settings where a seller sets some convenient defaults for the seller's data business. Sellers are preferably provided with a default set of discounts for their buyers. A seller may customize the seller's defaults, and further adjusts the defaults as needed. As shown in this figure, the seller advantageously searches the seller's data market by pixel or segment, by data provider, and/or by data buyer. The market place interface 1400 similarly lists information by pixel, data provider, data buyer, and further indicates whether the buyer is approved for the pixel, a suggested rate to pay the data provider (%), a suggested rate to charge the buyer for the data (%), actual rate(s), and whether there are active advertising line items targeting the listed pixel.

Data Protection

Some systems include built in functionality to discourage and/or prevent unauthorized use of data. One such unauthorized use is the copying or hijacking of a segment that a data provider has made efforts to identify and/or construct. To protect segments from undesirable hijacking, one implementation does not allow associating a user to a segment based on a potentially spurious activity, and/or one that is undesirably emulated such as, for example, viewing and/or clicking on a served page or advertisement. More specifically, an advertiser who has access to log file information has line item information including a particular ad campaign and/or advertisement served to a particular user. Preferably, this advertiser is not permitted to add the particular user for page loads, when the advertiser is targeting this same user. Accordingly, a first entity within the exchange system can not target a second entity's segment by generating a separate segment that duplicates all or part of the second entity's segment.

In a case where the first and second entities are direct competitors, some implementations do not allow hyperlinks from a URL belonging to the first entity to a URL belonging to the second entity, and vice versa. Preferably, in these situations, a user is added to a segment by unique pixel loads into the user's cache.

Some embodiments provide the ability to exclude and/or blacklist entities that are undesirable potential buyers such that excluded and/or blacklisted entities are unable to purchase and/or use the data from a seller's data provider. For direct competitors, this may reduce the likelihood of unauthorized use and/or copying of provider data and segments. Further, this may discourage the resale by an unauthorized entity that hijacks data. Preferably, however, the resale of data is permitted by authorized resellers, as described further below.

Data Exchange Data Providers

A data provider within the exchange preferably collects data including audience data and segments the audience data into user segments. A segment generally comprises a group of users who perform a certain action such as, for example, visiting a particular web page, and/or clicking on an advertisement. The exchange system preferably tracks each segment by using a segment identifier that is unique to a specific segment. The use of data providers is optional, and some entities such as data (collection) enabled networks may serve as the entity's own data provider. When an entity uses a separate data provider, the entity may manage the data provider and/or a group of several data providers for the collection, acquisition, and/or sale of data.

Managed data providers (MDPs) preferably log into selected portions of the system illustrated by FIGS. 8-14, described above. In one implementation, a data provider may selectively make private some or all of the data it provides on the exchange. For instance, the data provider advantageously defines a list of competitors that should not be able to benefit from its audience data. In this implementation, the list of excluded competitors may not view and/or purchase the selected private data provided by the data provider.

Data providers may be compensated a number of ways and at different times during the data exchange and/or targeting process. For instance, a network entity that uses a particular data provider may compensate the data provider for the data provided by the data provider to the network, for adding a user to a segment prior to the use of the data, and/or for targeting the user by using the segment later during an ad call and/or delivered impression, or other targeting event.

Seller Managed (Data Exchange) Buyers

In some implementations, a seller has functionality to manage exchange entities that are flagged as data exchange buyers. Seller management of buyer(s) includes, for example, the ability to provision or selectively enable particular entities as buyers of the seller's data. Selectively enabled buyers receive permission to buy segments. Further, seller management includes the ability to set pricing for each buyer, discounts for particular buyers, and/or to set default pricing. In this manner, only some entities are allowed data transactions on the exchange. Further, entities on the exchange are assigned and/or acquire different roles that have various advantages. For instance, some entities receive network reports of different types, while other entities have no or partial access to network reports. Moreover, within each entity, roles are assigned to different individuals to control the information and/or features that are available to each individual. In one example, the sales department of an entity may receive the ability to provision data buyers, set pricing, and view partial reports regarding the sale of data to these buyers, but not reports regarding all the segments that each buyer purchases from other entities. The roles that are assigned to an entity, and seller and/or network provisioning of an entity may determine whether the entity is self managed versus managed. As described above, self managed entities may have greater functionality than managed entities, which may depend upon a managing entity for certain features. Buyer(s) on the exchange are further described next.

Data Exchange Buyers

Preferably any self managed entity on the exchange is eligible to serve as a buyer of data. In one aspect of the invention, the buyers on the exchange are supplied a new targeting option on advertising line items (in the case of networks or publishers ) and/or advertising campaigns (in the case of advertisers). Generally, data in the form of audience segments are available to the buyer(s) at a price set by the seller of the data. When used on a line item, segment price impacts bid (e.g., a price reduction is incorporated into the bid). Such a price reduction further impacts the price of revenue share data.

Preferably, buyer(s) of data receive notifications if a seller of the data deactivates a pixel, an ad call, and/or a user segment that the buyers are using such as, for example, when an ad campaign no longer exists. For instance, deactivating an ad call and/or pixel may break the association of the ad call or pixel with a segment identifier. Preferably, buyers of a segment are notified when one or more segments that the buyers have purchased are altered in such a manner.

Competitive Exclusions

Buyers within the exchange are prevented from violating seller defined competitive exclusions for managed data providers. For instance, an entity Orbitz has user segment data for use and/or sale, but does not want a competitor Expedia targeting Orbitz's users and/or segment(s). Preferably, Orbitz has several options for protecting its data, users, and/or segments from competitive uses or bids. In one example, Orbitz makes a segment “Orbitz-users” private such that no buyers have access to bid or use the segment Orbitz-users. In this example, only Orbitz has visibility to use, modify, expand, and/or delete the segment Orbitz-users. Alternatively, Orbitz may define a competitive exclusion that more specifically prohibits its competitor Expedia from viewing, bidding, using, modifying, and the like, the segment Orbitz-users, while other potential buyers within the exchange may use the segment Orbitz-users. In both of the foregoing examples, the segment Orbitz-users cannot be targeted by Expedia, specifically and/or globally. In either case, the competitor Expedia is advantageously prevented from eligibility to bid on selected Orbitz users and/or segment(s). In some embodiments, such a feature is available on linked line items of ad calls.

Buyer Markups of Data

In certain cases, a buyer of data on the exchange has the ability to set a markup price on the data the buyer purchases when the buyer is targeting third party data to earn additional spread or increase profit margin on the purchase and re-sale of data such as user segment data.

III. Reports

Some embodiments include a number of advantageous reporting features for various different entities within the exchange. These reports provide information regarding the usage and impact of advertising that targets an entity's managed (data) segments, identify how users are added to the entity's managed segments, and/or yield insight into which web pages and/or sites the users of each segment are visiting.

Reporting for Sellers

Preferably, sellers are given the ability to view segment sizes and opportunity. These features are further discussed below in relation to the sample reports. More specifically, some embodiments have three or more different types of reports for sellers such as, for example, a data revenue report, a loads report, and a segment opportunity report.

Data Revenue Report

The data revenue report preferably provides information regarding who is buying a particular entity's segments, and how much each buyer is paying for a segment. The data revenue report preferably includes how much revenue is generated per segment on a daily and/or monthly basis, and how many ads are served that target each segment. The data revenue report may also inform data sellers how much the seller owes to their data providers such as for targeted impressions.

Loads Report

The loads report may include two subtypes including, for example, a segment size report and a verified-URL (VURL) report. The loads-segment-size-report includes how many unique users are in each segment. The loads-verified-URL report describes where, from which sites, do the page, and/or pixel loads come from. For instance, in one month a seller entity may have one million pixel loads. The seller may have pixels located on various sites such as, for example, a pixel on Edmunds.com, and a pixel on KBB.com. The loads-verified-URL report allows the seller to determine from which sites users are added. Stated differently, the seller may determine what percentage of total traffic across all the seller's data collection sites that adds to the seller's segments comes from each web site and/or page. Some loads reports may further provide how much is owed to a data provider for building a segment (e.g., for adding users to the segment).

Segment Opportunity Report

The segment opportunity report shows the total amount of activity across the exchange such as, for example, the total number of impressions served in a month across the exchange. For instance, in one month the total number of impressions served across the exchange may be ten million impressions. Of these ten million impressions, one million impressions served were targeting a particular segment. Accordingly, the remaining nine million impressions served in the month could have targeted the segment but did not target the particular segment. The segment opportunity report may also reveal to the seller which other third party networks are supplying the inventory that users in the segment are viewing and/or consuming.

Reporting for Data Providers

In some embodiments, one or more reports that are available to sellers are available to data providers within the exchange. For instance, some of these data providers may include managed data providers that are managed by the sellers described above. Accordingly, the reports available to data providers may include a data revenue report, a loads report, and/or a segment opportunity report. As mentioned above, the loads report may further include a loads-segment-size report and/or a loads-VURL report.

Reporting for Buyers

Reports for buyers may include a profit report, and/or a data cost report. The profit report includes how much money is the buyer making in general not just from segments, but from across the buyer's revenue sources including for example advertisers and/or networks with which the buyer has agreements. The data cost report includes how much is the buyer spending on segments, and who does the buyer owe money to at the end of each month that the buyer purchases segments including, for example, sellers, networks, and/or data providers.

IV. Data Exchange End Users

Preferably, the exchange system has one or more opt out mechanisms. For instance, a data exchange seller may not wish to provide data to the exchange system, and/or may not wish for its associated entities to use purchased exchange data. In these cases, the seller and/or buyer such as an individual network customizes its exchange preferences to disable various exchange functions by using one or more customization interfaces described above.

Further, some embodiments provide an opt-out solution for consumers and/or users within the exchange system. For instance, certain users may wish to opt out of being identified with a particular market/user segment. One implementation prevents the writing of segment identifiers to the user's cookie(s) at the user's option. More specifically, some implementations delete one or more exchange cookie(s), and/or insert an exchange opt-out instead for the user. Additionally, some systems provide a function that deletes all segment identifiers previously stored in the users' cache/cookie(s) or other data storage system. Users may access the function through a hyper link to a URL.

User Opt Outs

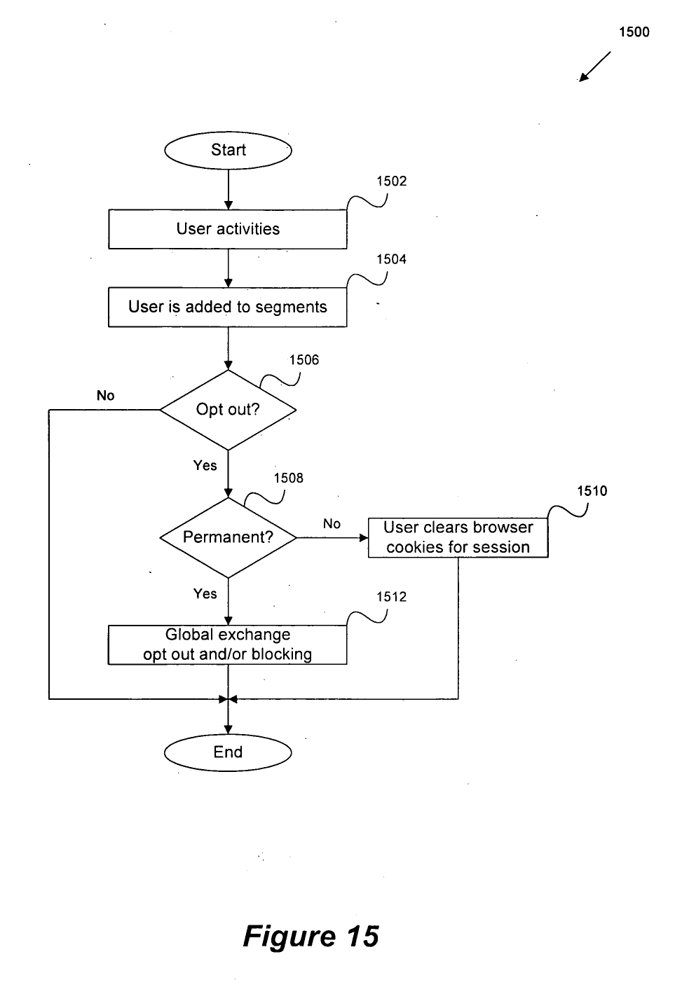

Particular implementations are further described in relation to the following process flows. For instance FIG. 15 illustrates a process 1500 for temporary and/or global exchange opt outs. As shown in this figure, the process 1500 begins at the step 1502, where a user performs or is involved with a variety of activities such as, for example, visiting web sites and pages within the sites. As the user is involved in these activities, the user is “segmented” and added to one or more user segments based on the user's activities, at the step 1504. As described above, one or more entities perform a variety of segmenting and/or data collection practices for the exchange including, for example, publishers, data providers, networks, and/or data sellers.

If the user does not object or is indifferent to the segmenting, then the process concludes after the step 1506. If, at the step 1506, however, the user decides to no longer be included in the segments or wishes to opt out, then the process 1500 transitions to the step 1508, where a determination is made as to whether the opt out is permanent. If the opt out is not permanent, then the user may perform, at the step 1510, a variety of temporary tasks that temporarily clears the user's browser cookies for the session, and the process 1500 concludes. If, at the step 1508, the opt out is permanent, then the process 1500 transitions to the step 1512, where a global exchange opt out function is performed for the user. The global exchange opt out function usually removes all of the segments to which the user has been added (e.g., from the user's cookie space), which effectively clears the user's “beacon” or segment history. Moreover, a special blocking cookie (or equivalent technology) such as, for example, an exchange blocking cookie is inserted instead into the user's cookie space. The blocking cookie preferably prevents future attempts to add user segments. In one embodiment, the blocking cookie prevents adding the user to segment(s) by blocking the addition of segment identifiers to the user's cookie space. After the step 1512, the process 1500 concludes.

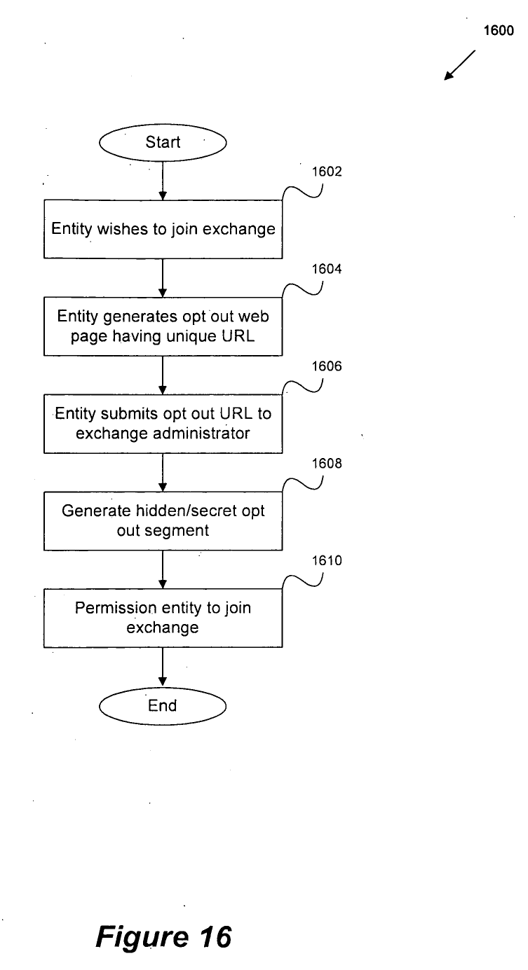

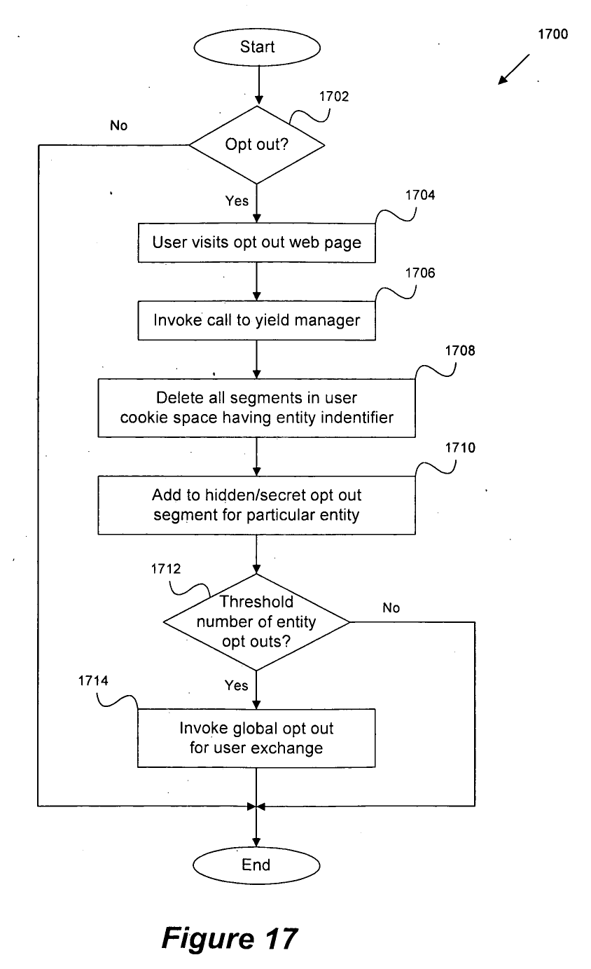

In the process 1500 of FIG. 15, the user may temporarily or permanently opt out of the segmenting performed by all entities on the exchange. It is not always desirable, however, to opt a user out completely from all entity activities on the exchange. For instance, there may be hundreds of entities or more on the exchange that perform independent user segmenting (e.g., BlueLithium, RevenueScience, Yahoo, and the like). While the user may wish to opt out of the segmenting performed by one entity, the user may not wish to opt out of all segmenting by all entities. Accordingly, FIGS. 16 and 17 illustrate processes 1600 and 1700, respectively that allow opting out of segments for particular entities rather than globally for the entire exchange. These embodiments advantageously operate alternatively, and/or in conjunction with the temporary/global opt out process 1500 of FIG. 15.

In view of the foregoing, FIG. 16 illustrates a process 1600 for granting an entity permission to join an exchange that particularly allows for entity-specific opt outs. As shown in this figure, the process 1600 begins at the step 1602, where an entity wishes to join the exchange. Then, at the step 1604, the entity generates a web page designed for opting out of the entity's data collection and/or segmenting activities. Preferably, the entity's opt out web page has a static and/or unique universal resource locator (URL) address. Next, at the step 1606, the entity submits the URL address for its opt out web page to an exchange administrator. The exchange administrator receives the submission at the step 1608, and generates (1) an entity identifier that is unique to the entity, and (2) a hidden and/or private opt out segment for the entity that corresponds to the entity identifier, and the URL for the entity's opt out page. Once the hidden, secret and/or private network information for the entity's opt out segment is generated at the step 1608, the new joining entity receives permission to join the exchange, at the step 1610. After the step 1610, the process 1600 concludes.

FIG. 17 illustrates a process 1700 that enables entity specific opt outs such as by using the setup configuration for the permissioned entity of FIG. 16. As shown in FIG. 17, the process 1700 begins at the step 1702, where a decision is made whether to opt out of a particular entity's data collection practices. If there is no opt out, then the process 1700 concludes. Otherwise, if the decision is to opt out, then the process 1700 transitions to the step 1704, where the user opting out visits the specific entity's web page for requesting opting out. As described above, the entity's opt out page has a static and/or unique URL address where the user navigates to indicate the selection for opting out. Some embodiments require that the entity place a predefined pixel within the opt out selection page such that when the user visits the page, the pixel executes a script and/or function call to indicate the opt out to the exchange. Some of these embodiments use an automated pixel and/or script such that the function call occurs without the need for user, entity, and/or exchange interaction. Preferably, the function call conveys the referring URL address for the entity's opt out page, thereby advantageously identifying the entity from which the user opts out, without the need for excessive additional information and/or processing. If the URL address is not recognized and/or matched, some implementations ignore the opt out request, and some implementations log an error, which may be used to detect potential abuse of the system.

Regardless of the particular implementation, after the step 1704, the process 1700 transitions to the step 1706, where the function call to indicate user opt out of the specific entity is invoked and/or sent. In some embodiments, the function call including, for example, the requesting entity's opt out page URL address, is sent to the exchange domain for the exchange. Then, at the step 1708, all the segment information for the specified entity is preferably deleted for the requesting user. More specifically, one embodiment uses the received URL address to identify the entity which is the subject of the user's opt out request, and to remove the user from the segments that match the entity identifier. In one implementation, the entity's segment identifiers within the requesting user's cookie space are deleted. Generally, each user may belong to approximately 200 segments. One of ordinary skill, however, recognizes that the number of user segment identifiers is based on the actual activities of the user on the exchange, and is only limited by the particular implementation of the segment storage system (e.g., the user's cookie space size for the implementations that use cookies to store user segment data).

Next, at the step 1710, the user is added to the hidden opt out segment for the particular entity. Accordingly, for future interactions of the requesting user with the opted-out entity, the exchange system recognizes the private and/or hidden opt out segment identifier for the entity and prohibits and/or refuses to add the user to the opted-out entity's segments. The process 1700 may optionally conclude here. Alternatively, the process 1700 of some embodiments includes additional features. For instance, the process 1700 may transition to the step 1712, where a determination is made whether this particular requesting user has repeatedly requested opting out from several entities' opt out web pages. If the user has made relatively few requests that are lower than a threshold number, then the process 1700 concludes. If, however, the particular user has requested several opt outs from several entities such as greater than the threshold number, for example, then the exchange system may determine and/or infer that the user prefers a global opt out from all entity data collection and/or segmentation on the exchange. In this situation, the process transitions to the step 1714, where a global exchange opt out function is invoked for the user. Some embodiments use the global exchange opt out steps described above in relation to FIG. 15 including, for example, deletion of all of the user's segments, and insertion of the global exchange blocking cookie. After the step 1714, the process 1700 concludes.

Although the techniques are described above in the online advertising context, the techniques are also applicable in any number of different open exchanges in which products, commodities or services are offered for purchase or sale. Further, many of the features described herein help data buyers to more effectively target users in audience segments, however, these features do not necessitate or guarantee that a particular behaviorally targeted advertisement wins a given auction, and/or is actually served to a user. Moreover, while data in the form of segment identifiers are generally stored and/or retrieved, embodiments of the invention preferably do not require any specific personal identifier information (e.g., name or social security number) to operate.

The techniques described herein may be implemented in digital electronic circuitry, or in computer hardware, firmware, software, or in combinations of them. The techniques may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program may be written in any form of programming language, including compiled or interpreted languages, and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network.

Method steps of the techniques described herein may be performed by one or more programmable processors executing a computer program to perform functions of the invention by operating on input data and generating output. Method steps may also be performed by, and apparatus of the invention may be implemented as, special purpose logic circuitry, e.g., an FPGA (field programmable gate array) or an ASIC (application-specific integrated circuit). Modules may refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer also includes, or is operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, the techniques described herein may be implemented on a computer having a display device, e.g., a CRT (cathode ray tube) or LCD (liquid crystal display) monitor, for displaying information to the user and a keyboard and a pointing device, e.g., a mouse or a trackball, by which the user provides input to the computer (e.g., interact with a user interface element, for example, by clicking a button on such a pointing device). Other kinds of devices are used to provide for interaction with a user as well; for example, feedback provided to the user includes any form of sensory feedback, e.g., visual feedback, auditory feedback, or tactile feedback; and input from the user is received in any form, including acoustic, speech, or tactile input.

The techniques described herein may be implemented in a distributed computing system that includes a back-end component, e.g., as a data server, and/or a middleware component, e.g., an application server, and/or a front-end component, e.g., a client computer having a graphical user interface and/or a Web browser through which a user interacts with an implementation of the invention, or any combination of such back-end, middleware, or front-end components. The components of the system may be interconnected by any form or medium of digital data communication, e.g., a communication network. Examples of communication networks include a local area network (“LAN”) and a wide area network (“WAN”), e.g., the Internet, and include both wired and wireless networks.

The computing system may include clients and servers. A client and server are generally remote from each other and typically interact over a communication network. The relationship of client and server arises by virtue of computer programs running on the respective computers and having a client-server relationship to each other. One of ordinary skill recognizes any or all of the foregoing implemented and described as computer readable media.

Other embodiments are within the scope of the following claims. The following are examples for illustration only and not to limit the alternatives in any way. The techniques described herein may be performed in a different order and still achieve desirable results.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A method of data collection for user segmentation, the method comprising:
receiving an interaction of a user with a web page;
generating an ad call in response to the received interaction, the ad call preconfigured to have an association to a first segment; and
adding the user to the first segment.

2. The method of claim 1, wherein the user interaction comprises one or more of:
loading the web page;
clicking on a portion of the web page; and
posting information in relation to the web page.

3. The method of claim 1, further comprising performing a targeting function for the user.

4. The method of claim 3, the targeting function comprising:
determining which entities are eligible to serve an ad for the ad call;
selecting an advertisement from an ad campaign of an eligible entity; and
delivering the selected advertisement for presentation to the user.

5. The method of claim 1, wherein the ad call has a format that includes:
a request for an advertisement for presentation on the web page;
one or more requirements for the requested advertisement, the requirements comprising one or more of a size requirement, and a type of ad requirement; and
an identifier for the requesting web page.

6. The method of claim 1, further comprising using a back end data storage coupled to a server for storing user segment information, the user segment information comprising segment identifiers that are unique for each segment.

7. The method of claim 1, further comprising using a user cookie space for storing user segment information comprising segment identifiers that are unique for each segment on the user's local machine.

8. The method of claim 1, wherein the ad call is triggered by using a pixel that is embedded within the web page.

9. A computer readable medium storing a program for data collection for user segmentation, the program comprising sets of instructions for:
receiving an interaction of a user with a web page;
generating an ad call in response to the received interaction, the ad call preconfigured to have an association to a first segment; and
adding the user to the first segment.

10. The computer readable medium of claim 9, wherein the user interaction comprises one or more of:
loading the web page;
clicking on a portion of the web page; and
posting information in relation to the web page.

11. The computer readable medium of claim 9, further comprising instructions for performing a targeting function for the user.

12. The computer readable medium of claim 11, the instructions for performing the targeting function comprising instructions for:
determining which entities are eligible to serve an ad for the ad call;
selecting an advertisement from an ad campaign of an eligible entity; and
delivering the selected advertisement for presentation to the user.

13. The computer readable medium of claim 9, wherein the ad call has a format that includes:
a request for an advertisement for presentation on the web page;
one or more requirements for the requested advertisement, the requirements comprising one or more of a size requirement, and a type of ad requirement; and
an identifier for the requesting web page.

14. The computer readable medium of claim 9, further comprising instructions for using a back end data storage coupled to a server for storing user segment information, the user segment information comprising segment identifiers that are unique for each segment.

15. The computer readable medium of claim 9, further comprising instructions for using a user cookie space for storing user segment information comprising segment identifiers that are unique for each segment on the user's local machine.

16. The computer readable medium of claim 9, wherein the ad call is triggered by using a pixel that is embedded within the web page.

17. A system for data collection for user segmentation, the system configured for:
receiving an interaction of a user with a web page;
generating an ad call in response to the received interaction, the ad call preconfigured to have an association to a first segment; and
adding the user to the first segment.

18. The system of claim 17, wherein the user interaction comprises one or more of:
loading the web page;
clicking on a portion of the web page; and
posting information in relation to the web page.

19. The system of claim 17, further comprising a targeting module for performing a targeting function for the user.

20. The system of claim 19, the targeting function comprising:
determining which entities are eligible to serve an ad for the ad call;
selecting an advertisement from an ad campaign of an eligible entity; and
delivering the selected advertisement for presentation to the user.

21. The system of claim 17, wherein the ad call has a format that includes:
a request for an advertisement for presentation on the web page;
one or more requirements for the requested advertisement, the requirements comprising one or more of a size requirement, and a type of ad requirement; and
an identifier for the requesting web page.

22. The system of claim 17, further comprising a back end data storage coupled to a server for storing user segment information, the user segment information comprising segment identifiers that are unique for each segment.

23. The system of claim 17, further comprising a user cookie space for storing user segment information comprising segment identifiers that are unique for each segment on the user's local machine.

24. The system of claim 17, wherein the ad call is triggered by using a pixel that is embedded within the web page.
